(19) United States
(12) Patent Application Publication
(10) Pub. No.: US 2017/0250905 A1
(43) Pub. Date: Aug. 31, 2017

(54) COMMUNICATION METHOD IN DIVIDED VEHICLE NETWORK

(71) Applicants: Hyundai Motor Company, Seoul (KR); Kia Motors Corporation, Seoul (KR); Kyungshin Corp., Incheon (KR)

(72) Inventors: Seong Jin Park, Suwon (KR); Woo Sub Kim, Namyangju (KR); Jae Goo Jung, Incheon (KR); Jae Sung Bae, Incheon (KR)

(21) Appl. No.: 15/441,703

(22) Filed: Feb. 24, 2017

(30) Foreign Application Priority Data
Feb. 26, 2016 (KR) 10-2016-0023719

(51) Int. Cl. H04L 12/721; H04L 29/12

(52) U.S. Cl. CPC H04L 45/72; H04L 61/6022; H04L 61/2007; H04L 45/66

(57) ABSTRACT

Disclosed are communication methods in a divided vehicle network. An operation method of a first end node includes: generating a frame; and transmitting the frame to a switch connected to the first end node. A source internet protocol (IP) address of the frame is set to an IP address of the first end node, a destination IP address of the frame is set to an IP address of a second end node belonging to a second domain in the vehicle network, a source medium access control (MAC) address of the frame is set to a MAC address of the first end node, and a destination MAC address of the frame is set to a MAC address of a gateway supporting inter-domain communications.

### CROSS-REFERENCE TO RELATED APPLICATION

This application claims the benefit of and priority to Korean Patent Application No. 10-2016-0023719, filed on Feb. 26, 2016 in the Korean Intellectual Property Office (KIPO), the entirety of which is incorporated by reference as if fully set forth herein.

### BACKGROUND

1. Technical Field

The present disclosure relates generally to communication methods, and more specifically, to communication methods in which a virtual medium access control (MAC) address is used in a divided vehicle network.

2. Description of the Related Art

The number and variety of electronic devices installed within a vehicle have been increasing significantly along with the recent digitalization of vehicle parts. Electronic devices may currently be used throughout the vehicle, such as in a power train control system (e.g., an engine control system, an automatic transmission control system, or the like), a body control system (e.g., a body electronic equipment control system, a convenience apparatus control system, a lamp control system, or the like), a chassis control system (e.g., a steering apparatus control system, a brake control system, a suspension control system, or the like), a vehicle network (e.g., a controller area network (CAN), a FlexRay-based network, a media oriented system transport (MOST)-based network, or the like), a multimedia system (e.g., a navigation apparatus system, a telematics system, an infotainment system, or the like), and so forth.

The electronic devices comprising each of these systems are connected via the vehicle network, which supports functions of the electronic devices. For instance, the CAN may support a transmission rate of up to 1 Mbps and may support automatic retransmission of colliding messages, error detection based on a cycle redundancy interface (CRC), or the like. The FlexRay-based network may support a transmission rate of up to 10 Mbps and may support simultaneous transmission of data through two channels, synchronous data transmission, or the like. The MOST-based network is a communication network for high-quality multimedia, which may support a transmission rate of up to 150 Mbps.

Meanwhile, the telematics system, the infotainment system, as well as enhanced safety systems of a vehicle, require higher transmission rates and system expandability. However, the CAN, FlexRay-based network, and the like may not sufficiently support such requirements. The MOST-based network, in particular, may support a higher transmission rate than the CAN and the FlexRay-based network. However, applying the MOST-based network to vehicle networks can be costly.

Due to these limitations, an Ethernet-based network is often utilized as a vehicle network. The Ethernet-based network may support bi-directional communication through one pair of windings and may support a transmission rate of up to 10 Gbps.

In addition, the amount of data traffic may increase due to the increasing number of electronic devices comprising a vehicle network, and accordingly the load of the vehicle network may also increase. In order to distribute the load of the vehicle network, a virtual local area network (VLAN) technique may be used for the vehicle network. The vehicle network to which the VLAN related technique is applied may be divided into at least one domain. For example, a switch constituting the vehicle network may be connected to an end node belonging to a first domain, and an end node and a router (or, a gateway, etc.) belonging to a second domain. Communications between end nodes belonging to different domains may be supported through switches and routers. For this, the switch is required to support layer-3 related functions, and the router is required to have network interface cards (NICs) for respective domains.

Since switches supporting layer-3 functions and routers including a plurality of NICs are necessary for communications between end nodes belonging to different domains in the vehicle network to which the VLAN technique is applied, the communications between end nodes belonging to different domains may cause implementation difficulty due to higher cost and complexity.

### SUMMARY

The present disclosure provides a method for dividing a vehicle network. The present disclosure also provides a communication method in a divided vehicle network.

In accordance with embodiments of the present disclosure, an operation method of a first end node belonging to a first domain in a vehicle network includes: generating a frame; and transmitting the frame to a switch connected to the first end node. A source internet protocol (IP) address of the frame is set to an IP address of the first end node, a destination IP address of the frame is set to an IP address of a second end node belonging to a second domain in the vehicle network, a source medium access control (MAC) address of the frame is set to a MAC address of the first end node, and a destination MAC address of the frame is set to a MAC address of a gateway supporting inter-domain communications.

The switch may support layer-2 functions, and configure domains for respective ports of the switch.

The gateway may have MAC addresses for the first and second domains, and a MAC address of the gateway set as the destination MAC address of the frame may be a MAC address configured for the first domain.

The gateway may have a plurality of MAC addresses, one of the plurality of MAC addresses may be a physical MAC address, and the remainder of the plurality of MAC addresses may be virtual MAC addresses.

Further, in accordance with embodiments of the present disclosure, an operation method of a switch in a vehicle network includes: receiving a frame from a first end node belonging to a first domain in the vehicle network; identifying a communication node indicated by a destination medium access control (MAC) address of the frame; and transmitting the frame to a gateway supporting inter-domain communications when the identified communication node is the gateway.

A source internet protocol (IP) address of the frame may be set to an IP address of the first end node, and a destination IP address of the frame may be set to an IP address of a second end node belonging to a second domain in the vehicle network.

The destination MAC address of the frame may be a MAC address configured for the first domain.

The switch supports layer-2 functions, and configures domains for respective ports of the switch.

The frame may be received from the first end node through a first port configured for the first domain.

The operation method may further include: receiving the frame from the gateway; identifying a communication node indicated by a changed destination MAC address of the frame received from the gateway; and transmitting the frame to a second end node belonging to a second domain in the vehicle network when the identified communication node is the second end node.

A source MAC address of the frame received from the gateway may be a MAC address configured for the second domain.

The frame may be received from the second end node through a second port configured for the second domain.

Further, in accordance with embodiments of the present disclosure, an operation method of a gateway in a vehicle network includes: receiving a frame from a switch; changing a destination medium access control (MAC) address of the frame to a MAC address of an end node indicated by a destination internet protocol (IP) address of the frame, when the frame is used for communication between end nodes belonging to different domains; and transmitting the frame having the changed destination MAC address to the switch.

The destination MAC address of the frame received from the switch may be a MAC address configured for a domain to which an end node indicated by a source IP address or a source MAC address of the frame belongs.

The frame may be used for communication between end nodes belonging to different domains, when a domain to which an end node indicated by a source IP address or a source MAC address of the frame belongs is different from a domain to which an end node indicated by the destination IP address of the frame belongs.

The frame may be used for communication between end nodes belonging to different domains, when a domain corresponding to a MAC address of the gateway which is configured as the destination MAC address of the frame is different from a domain to which an end node indicated by the destination IP address of the frame belongs.

A source MAC address of the frame may be changed to a MAC address configured for a domain to which an end node indicated by the destination IP address of the frame belongs.

The gateway supports inter-domain communications and has MAC addresses configured for one or more domains.

The gateway may have a plurality of MAC addresses, one of the plurality of MAC addresses may be a physical MAC address, and the remainder of the plurality of MAC addresses may be virtual MAC addresses.

The gateway may include a single network interface card (NIC).

According to the present disclosure, a vehicle network can be divided into a plurality of domains (or, VLANs) so that load of the vehicle network can be reduced. Accordingly, bandwidth of the vehicle network can be increased, and restriction on installation positions of communication nodes can be reduced, and thus it can become possible to design the vehicle network with flexibility. Also, switches supporting only layer-2 functions and gateways having a single NIC can be used, whereby a desired vehicle network can be constructed with relatively lower cost.

Further, security of the vehicle network can be enhanced by separating the vehicle network from external networks. Especially, in a case that diagnostics based on diagnostic over IP (DoIP) are being performed, security between end nodes belonging to the vehicle network and a diagnostic apparatus locating in the external network can be remarkably enhanced.

### BRIEF DESCRIPTION OF DRAWINGS

Forms of the present disclosure will become more apparent by describing in detail forms of the present disclosure with reference to the accompanying drawings, in which:

FIG. 1 is a diagram showing a vehicle network topology according to embodiments of the present disclosure;

FIG. 2 is a diagram showing a communication node constituting a vehicle network according to embodiments of the present disclosure;

FIG. 3 is a block diagram illustrating an example of a CAN-based vehicle network topology;

FIG. 4 is a block diagram illustrating a first exemplary embodiment of a vehicle network topology to which a port based VLAN technology is applied;

FIG. 5 is a sequence chart illustrating a first exemplary embodiment of a communication method in a vehicle network according to the present disclosure;

FIG. 6 is a block diagram illustrating a second exemplary embodiment of a vehicle network topology to which a port based VLAN technology is applied;

FIG. 7 is a sequence chart illustrating a second exemplary embodiment of a communication method in a vehicle network according to the present disclosure;

FIG. 8 is a block diagram illustrating a third exemplary embodiment of a vehicle network topology to which a port based VLAN technology is applied;

FIG. 9 is a sequence chart illustrating a third exemplary embodiment of a communication method in a vehicle network according to the present disclosure;

FIG. 10 is a block diagram illustrating a fourth exemplary embodiment of a vehicle network topology to which a port based VLAN technology is applied; and

FIG. 11 is a block diagram illustrating a fifth exemplary embodiment of a vehicle network topology to which a port based VLAN technology is applied.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular forms only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g., fuels derived from resources other than petroleum).

Although embodiments are described herein as using a plurality of units to perform the exemplary process, it is understood that the exemplary processes may also be performed by one or plurality of modules. Additionally, it is understood that the term controller/controller unit/control unit refers to a hardware device that includes a memory and a processor. The memory is configured to store the modules, and the processor is specifically configured to execute said modules to perform one or more processes which are described further below. Moreover, it is understood that the units or modules described herein may embody a controller/control unit for controlling operation of the unit or module.

Further, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Since the present disclosure may be variously modified and have several forms, specific embodiments will be shown in the accompanying drawings and be described in detail in the detailed description. It should be understood, however, that it is not intended to limit the present disclosure to the specific embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without being departed from the scope of the present disclosure and the second component may also be similarly named the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be located therebetween. In contrast, when it is mentioned that a certain component is “directly coupled with” or “directly connected with” another component, it will be understood that a further component is not located therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless otherwise defined, all terms (including technical and scientific terms) used herein have the same meaning as commonly understood by one of ordinary skill in the art to which this disclosure belongs. Terms such as terms that are generally used and have been in dictionaries should be construed as having meanings matched with contextual meanings in the art. In this description, unless defined clearly, terms are not ideally, excessively construed as formal meanings.

Hereinafter, embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

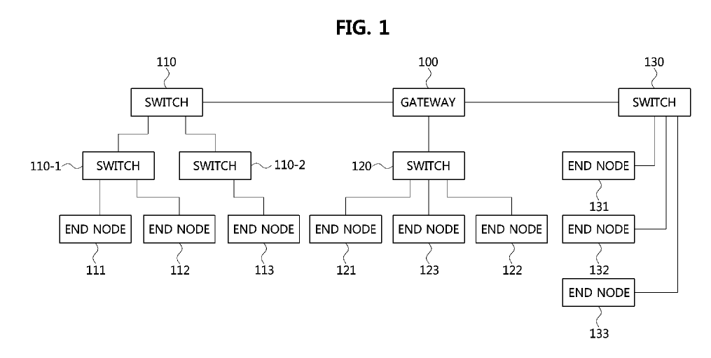

FIG. 1 is a diagram showing a vehicle network topology according to embodiments of the present disclosure.

As shown in FIG. 1, a communication node included in the vehicle network may be a gateway, a switch (or bridge), or an end node. The gateway 100 may be connected with at least one switch 110, 110-1, 110-2, 120, and 130 and may be configured to connect different networks. For example, the gateway 100 may support connection between a switch which supports a controller area network (CAN) (e.g., FlexRay, media oriented system transport (MOST), or local interconnect network (LIN)) protocol and a switch which supports an Ethernet protocol. Each of the switches 110, 110-1, 110-2, 120, and 130 may be connected to at least one of end nodes 111, 112, 113, 121, 122, 123, 131, 132, and 133. Each of the switches 110, 110-1, 110-2, 120, and 130 may interconnect the end nodes 111, 112, 113, 121, 122, 123, 131, 132, and 133, and control at least one of end nodes 111, 112, 113, 121, 122, 123, 131, 132, and 133 connected to the switch.

The end nodes 111, 112, 113, 121, 122, 123, 131, 132, and 133 may include an electronic control unit (ECU) configured to control various types of devices mounted within a vehicle. For example, the end nodes 111, 112, 113, 121, 122, 123, 131, 132, and 133 may include the ECU included in an infotainment device (e.g., a display device, a navigation device, and an around view monitoring device).

The communication nodes (e.g., a gateway, a switch, an end node, or the like) included in the vehicle network may be connected in a star topology, a bus topology, a ring topology, a tree topology, a mesh topology, or the like. In addition, the communication nodes of the vehicle network may support the CAN protocol, the FlexRay protocol, the MOST protocol, the LIN protocol, or the Ethernet protocol. Forms of the present disclosure may be applied to the foregoing network topologies. The network topology to which embodiments of the present disclosure may be applied is not limited thereto and may be configured in various ways.

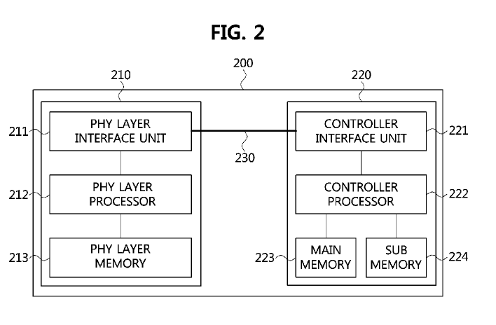

FIG. 2 is a diagram showing a communication node constituting a vehicle network according to embodiments of the present disclosure. Notably, the various methods discussed herein below may be executed by a controller having a processor and a memory.

As shown in FIG. 2, a communication node 200 of a network may include a PHY layer unit 210 and a controller unit 220. In addition, the communication node 200 may further include a regulator (not shown) for supplying power. In particular, the controller unit 220 may be implemented to include a medium access control (MAC) layer. A PHY layer unit 210 may be configured to receive or transmit signals from or to another communication node. The controller unit 220 may be configured to control the PHY layer unit 210 and perform various functions (e.g., an infotainment function, or the like.). The PHY layer unit 210 and the controller unit 220 may be implemented as one system on chip (SoC), or alternatively may be implemented as separate chips.

Further, the PHY layer unit 210 and the controller unit 220 may be connected via a media independent interface (MII) 230. The MII 230 may include an interface defined in the IEEE 802.3 and may include a data interface and a management interface between the PHY layer unit 210 and the controller unit 220. One of a reduced MII (RMII), a gigabit MII (GMII), a reduced GMII (RGMII), a serial GMII (SGMII), a 10 GMII (XGMII) may be used instead of the MII 230. A data interface may include a transmission channel and a reception channel, each of which may have an independent clock, data, and a control signal. The management interface may include a two-signal interface, one signal for the clock and one signal for the data.

Particularly, the PHY layer unit 210 may include a PHY layer interface unit 211, a PHY layer processor 212, and a PHY layer memory 213. The configuration of the PHY layer unit 210 is not limited thereto, and the PHY layer unit 210 may be configured in various ways. The PHY layer interface unit 211 may be configured to transmit a signal received from the controller unit 220 to the PHY layer processor 212 and transmit a signal received from the PHY layer processor 212 to the controller unit 220. The PHY layer processor 212 may be configured to execute operations of the PHY layer interface unit 211 and the PHY layer memory 213. The PHY layer processor 212 may be configured to modulate a signal to be transmitted or demodulate a received signal. The PHY layer processor 212 may be configured to control the PHY layer memory 213 to input or output a signal. The PHY layer memory 213 may be configured to store the received signal and output the stored signal based on a request from the PHY layer processor 212.

The controller unit 220 may be configured to monitor and control the PHY layer unit 210 using the MII 230. The controller unit 220 may include a controller interface unit 221, a controller processor 222, a main memory 223, and a sub memory 224. The configuration of the controller unit 220 is not limited thereto, and the controller unit 220 may be configured in various ways. The controller interface unit 221 may be configured to receive a signal from the PHY layer unit 210 (e.g., the PHY layer interface unit 211) or an upper layer (not shown), transmit the received signal to the controller processor 222, and transmit the signal received from the controller processor 222 to the PHY layer unit 210 or upper layer. The controller processor 222 may further include an independent memory control logic or an integrated memory control logic for controlling the controller interface unit 221, the main memory 223, and the sub memory 224. The memory control logic may be implemented to be included in the main memory 223 and the sub memory 224 or may be implemented to be included in the controller processor 222.

Further, each of the main memory 223 and the sub memory 224 may be configured to store a signal processed by the controller processor 222 and may be configured to output the stored signal based on a request from the controller processor 222. The main memory 223 may be a volatile memory (e.g., a random access memory (RAM)) configured to temporarily store data required for the operation of the controller processor 222. The sub memory 224 may be a non-volatile memory in which an operating system code (e.g., a kernel and a device driver) and an application program code for performing a function of the controller unit 220 may be stored. A flash memory having a high processing speed, a hard disc drive (HDD), or a compact disc-read only memory (CD-ROM) for large capacity data storage may be used as the non-volatile memory. Typically, the controller processor 222 may include a logic circuit having at least one processing core. A core of an Advanced RISC Machines (ARM) family or a core of an Atom family may be used as the controller processor 222.

A method performed by a communication node and a corresponding counterpart communication node in a vehicle network will be described below. Although the method (e.g., signal transmission or reception) performed by a first communication node will be described below, the method is applicable to a second communication node that corresponds to the first communication node. In other words, when an operation of the first communication node is described, the second communication node corresponding thereto may be configured to perform an operation that corresponds to the operation of the first communication node. Additionally, when an operation of the second communication node is described, the first communication node may be configured to perform an operation that corresponds to an operation of a switch.

Due to the increasing number of end nodes in a CAN-based vehicle network, load of the vehicle network can be increased. In order to distribute the increased network load, a plurality of domains for respective functions of a vehicle may be configured.

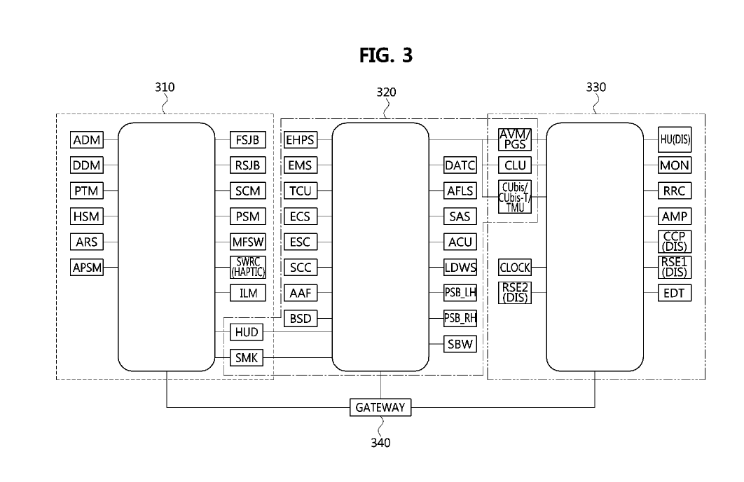

FIG. 3 is a block diagram illustrating an example of a CAN-based vehicle network topology.

As shown in FIG. 3, the CAN-based vehicle network may be divided into a body control domain 310, a chassis control domain 320, and a multimedia domain 330. End nodes ADM, DDM, PTM, HSM, ARS, APSM, FSJB, RSJB, SCM, PSM, MFSW, SWRC (HAPTIC), ILM, HUD, and SMK, belonging to the body control domain 310, may perform body electronic equipment control functions, convenience equipment control functions, lamp control functions and so on. The end nodes belonging to the body control domain 310 may be connected through a bus, and support transmission speed up to 100 Kbps.

End nodes EHPS, EMS, TCU, ECS, ESC, SCC, AAF, BSD, HUD, SMK, AVM/PGS, CLU, CUbiS/CUbiS-T/TMU, DATC, AFLS, SAS, ACU, LDWS, PSB_LH, PSB_RH, and SBW, belonging to the chassis control domain 320, may perform steering system control functions, break control functions, suspension control functions and so on. The end nodes belonging to the chassis control domain 320 may also be connected through a bus, and support transmission speed up to 500 Kbps.

End nodes AVM/PGS, CLU, CUbiS/CUbiS-T/TMU, CLOCK, RSE2 (DIS), HU (DIS), MON, RRC, AMP, CCP (DIS), RSE1 (DIS), and EDT, belonging to the multimedia domain 330, may perform navigation functions, telematics functions, infotainment functions and so on. The end nodes belonging to the multimedia domain 330 may also be connected through a bus, and support transmission speed up to 100 Kbps.

Meanwhile, end nodes (e.g., HUD and SMK) belonging to both of the body control domain 310 and the chassis control domain 320, and end nodes (e.g., AVM/PGS, CLU, and CUbiS/CUbiS-T/TMU) belonging to both of the chassis control domain 320 and the multimedia domain 330 may exist. The domains 310, 320, and 330 may be connected to a gateway 340, and communications between end nodes belonging to different domains may be performed through the gateway 340. For example, when a first end node belonging to the body control domain 310 wants to transmit a frame to a second end node belonging to the chassis control domain 320, the first end node may transmit to the gateway 340 a frame indicating the second end node as its destination. The gateway 340 may receive the frame from the first end node, identify that the destination of the received frame is the second end node, and transmit the received frame to the second end node.

Meanwhile, virtual local area network (VLAN) technologies may be applied to a vehicle network. The VLAN technologies may be classified into MAC address based VLAN technologies, port based VLAN technologies, etc. In case that the MAC address based VLAN technology is applied to the vehicle network, the vehicle network may be dynamically divided into a least one domain. Here, a domain may correspond to a VLAN. In the vehicle network to which the MAC address based VLAN technology is applied, a separate server (e.g., a VLAN management policy server (VMPS), etc.) for storing and managing MAC addresses of communication nodes belonging to domains becomes necessary, and communications between nodes may be performed in a rather complicated manner. In case that the port based VLAN technology is applied to the vehicle network, the vehicle network may be statically divided into at least one domain.

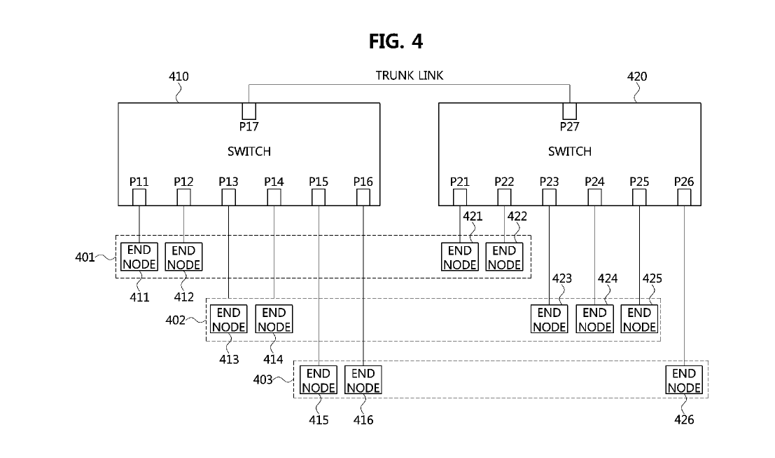

FIG. 4 is a block diagram illustrating a first exemplary embodiment of a vehicle network topology to which a port based VLAN technology is applied.

As shown in FIG. 4, in the vehicle network, domains may be assigned to respective ports of the switches 410 and 420. For example, end nodes 411 and 412 connected to ports P11 and P12 of the switch 410, and end nodes 421 and 422 connected to ports P21 and P22 of the switch 420 may belong to a first domain 401. End nodes 413 and 414 connected to ports P13 and P14 of the switch 410, and end nodes 423, 424, and 425 connected to ports P23, P24, and P25 of the switch 420 may belong to a second domain 402. End nodes 415 and 416 connected to ports P15 and P16 of the switch 410, and an end node 426 connected to a port P26 of the switch 420 may belong to a third domain 403.

Table 1 below shows mapping relations among domains, ports, and MAC addresses. Here, the MAC addresses may be MAC addresses of communication nodes connected to the corresponding ports. Communication nodes constituting the vehicle network may have the mapping table in advance.

TABLE 1

| Domain | Port | MAC address |
|---|---|---|
| First | P11 | M11 |
| Domain | P12 | M12 |
| | P21 | M21 |
| | P22 | M22 |
| Second | P13 | M13 |
| Domain | P14 | M14 |
| | P23 | M23 |
| | P24 | M24 |
| | P25 | M25 |
| Third | P15 | M15 |
| Domain | P16 | M16 |
| | P26 | M26 |

The switch 410 and the switch 420 may be connected through a trunk link, and communications between end nodes which are connected to different switches and belong to different domains may be performed through the trunk link. Communications between end nodes belonging to the same domain may be performed as follows.

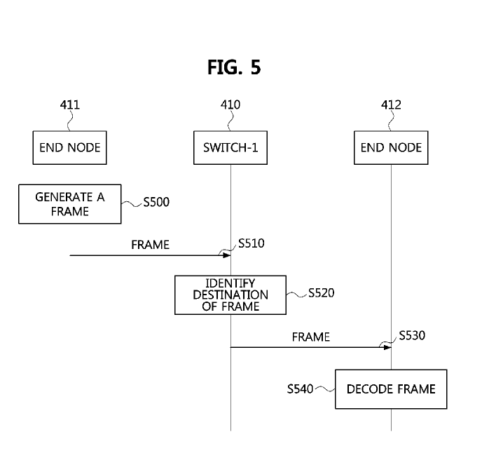

FIG. 5 is a sequence chart illustrating a first exemplary embodiment of a communication method in a vehicle network according to the present disclosure.

As shown in FIG. 5, the switch 410 and end nodes 411 and 412 may be corresponding nodes illustrated in FIG. 4, and constitute the vehicle network illustrated in FIG. 4. The end nodes 411 and 412 may belong to the first domain 401. The end node 411 may be connected to the switch 410 via the port P11, and the end node 412 may be connected to the switch 410 via the port P12. As shown in the table 1, the MAC address of the end node 411 may be M11, and the MAC address of the end node 412 may be M12.

The end node 411 may generate a frame to be transmitted to the end node 412 (S500). The frame may comprise address information and a payload. A destination MAC address of the frame may be configured to be M12 which is the MAC address of the end node 412, and a source MAC address of the frame may be configured to be M11 of the MAC address of the end node 411. The end node 411 may transmit the frame to the switch 410 via the port P11 (S510). The switch 410 may receive the frame from the end node 411. Since the frame is received through the port P11, the switch 410 may identify that the frame has been transmitted from the end node 411 connected to the port P11. Additionally or alternatively, by identifying that source MAC address of the received frame, the switch 410 may identify that the frame has been transmitted from the end node 411.

Also, the switch 410 may identify the destination MAC address of the received frame (S520). Since the destination MAC address of the frame is configured as M12 which is the MAC address of the end node 412, the switch 410 may identify that the destination of the frame is the end node 412. The switch 410 may transmit the frame to the end node 412 through the port P12 (S530). The end node 412 may receive the frame from the switch 410, and identify that the destination of the frame is the end node 412 by checking the destination MAC address of the received frame. Therefore, the end node 412 may decode the payload included in the frame (S540).

Referring once again to FIG. 4, in a case that the switches 410 and 420 support only layer-2 functions (i.e., when the switches 410 and 420 do not support layer-3 functions), since the switches 410 and 420 cannot identify IP addresses of the frame, communications between end nodes belonging to different domains may not be supported. However, if the switches 410 and 420 support layer-3 functions and are connected to a router (e.g., a router having network interface cards (NICs) for respective domains, communications between end nodes belonging to different domains may be supported.

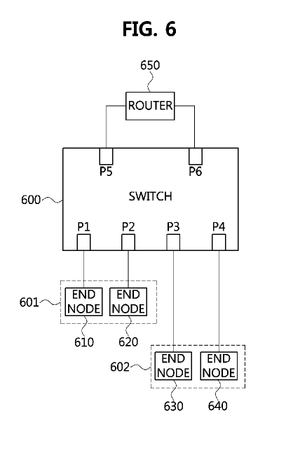

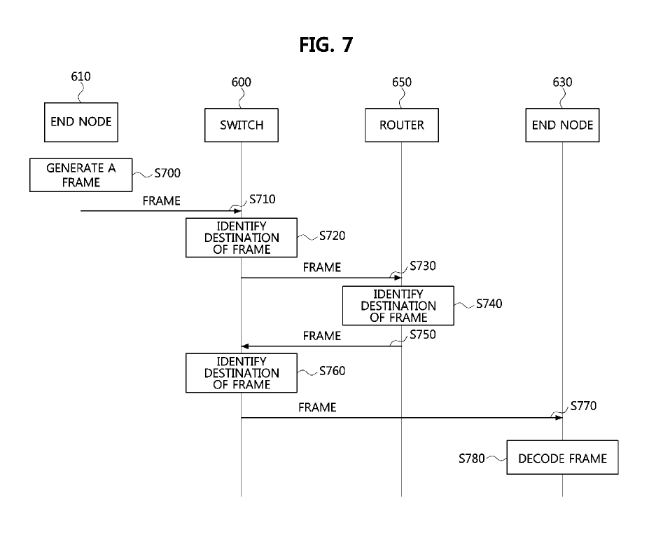

FIG. 6 is a block diagram illustrating a second exemplary embodiment of a vehicle network topology to which a port based VLAN technology is applied, and FIG. 7 is a sequence chart illustrating a second exemplary embodiment of a communication method in a vehicle network according to the present disclosure.

As shown in FIGS. 6 and 7, a switch 600 may support layer-3 functions. Also, domains 601 and 602 are assigned to respective ports of the switch 600. For example, end nodes 610 and 620 connected to ports P1 and P2 of the switch 600 may belong to a first domain 601, and end nodes 630 and 640 connected to ports P3 and P4 of the switch 600 may belong to a second domain 602. A port P5 of the switch 600 may be configured for the first domain 601, and the port P6 of the switch 600 may be configured for the second domain 602. That is, the port P5 of the switch 600 may be used for supporting communications with the end nodes 610 and 620 belonging to the first domain 601, and the port P6 of the switch 600 may be used for supporting communications with the end nodes 630 and 640 belonging to the second domain 602.

The switch 600 may be connected to a router 650 through the ports P5 and P6. The router 650 may comprise NICs for respective domains 601 and 602. For example, the router 650 may comprise a first NIC for the first domain 601 and a second NIC for the second domain 602. Thus, the router 650 may have IP addresses and MAC addresses for respective domains 601 and 602. Table 2 below shows mapping relations among domains, ports, MAC addresses, and IP addresses. Here, the MAC address may be a MAC address of a communication node connected to the corresponding port, and the IP address may be an IP address of a communication node connected to the corresponding port. Communication nodes constituting the vehicle network may have the mapping table in advance.

TABLE 2

| Domain | Port | MAC address | IP address |
|---|---|---|---|
| First | P1 | M1 | 192.168.0.2 |
| Domain | P2 | M2 | 192.168.0.3 |
| | P5 | M5 | 192.168.0.1 |
| Second | P3 | M3 | 192.168.1.2 |
| Domain | P4 | M4 | 192.168.1.3 |
| | P6 | M6 | 192.168.1.1 |

The end node 610 may generate a frame to be transmitted to the end node 630 (S700). The frame may comprise address information and a payload. A destination IP address of the frame may be configured to be 192.168.1.2 which is the IP address of the end node 630, and a source IP address of the frame may be configured to be 192.168.0.2 which is the IP address of the end node 610. Also, a destination MAC address of the frame may be configured to be M3 which is the MAC address of the end node 630 or M5 which is the MAC address for the first domain 601 among MAC addresses of the router 650, and a source MAC address of the frame may be configured to be M1 which is the MAC address of the end node 610. The end node 610 may transmit the frame to the switch 600 through the port P1 (S710). The switch 600 may receive the frame from the end node 610. Since the frame is received through the port P1, the switch 600 may identify that the frame has been transmitted from the end node 610 connected to the port P1. Additionally or alternatively, the switch 600 may identify that the frame has been transmitted from the end node 610 by checking the source MAC (or IP) address of the frame.

Also, the switch 600 may identify the destination IP address of the received frame (S720). Since the destination IP address of the frame is configured as 192.168.1.2 which is the IP address of the end node 630, the switch 600 may identify that the destination of the frame is the end node 630 belonging to the second domain 602. Since the frame is for communication between the end nodes 610 and 630 belonging to different domains, the switch 600 may transmit the frame to the router 650 via the port P5 (S730).

The router 650 may receive the frame from the switch 600. The router 650 may identify that the destination IP address of the received frame is 192.168.1.2 which is the IP address of the end node 630, and accordingly identify that the destination of the frame is the end node 630 belonging to the second domain 602 (S740). Here, in a case that the destination MAC address of the frame is configured as M5 which is the MAC address for the first domain 601 among MAC addresses of the router 650, the router 650 may change the destination MAC address of the frame from M5 to M3 which is the MAC address of the end node 630, and change the source MAC address of the frame to M6 which is the MAC address for the second domain 602 among MAC addresses of the router 650. The router 650 may transmit the frame to the switch 600 through the port P6 configured for the second domain 602 (S750).

The switch 600 may receive the frame from the router 650, and identify that the destination of the frame is the end node 630 by checking the destination IP (or, MAC) address of the received frame (S760). The switch 600 may transmit the frame to the end node 630 through the port P3 (S770). The end node 630 may receive the frame from the switch 600, and identify that the destination of the frame is the end node 630 by checking the destination IP (or, MAC) address of the received frame. Accordingly, the end node 630 may decode the payload included in the received frame (S780).

As described above, in order to support communications between end nodes belonging to different domains, switches supporting layer-3 functions and a router comprising a plurality of NICs (i.e., NICs for respective domains) are demanded. In a vehicle network, the switches support layer-3 functions and the router comprising a plurality of NICs may become a reason of increasing cost of a vehicle, and thus it is not easy to divide a vehicle network into a plurality of domains. Hereinafter, a vehicle network, which is divided into a plurality of domains by using switches supporting only layer-2 functions and a communication (e.g., gateway) having a single NIC, will be described.

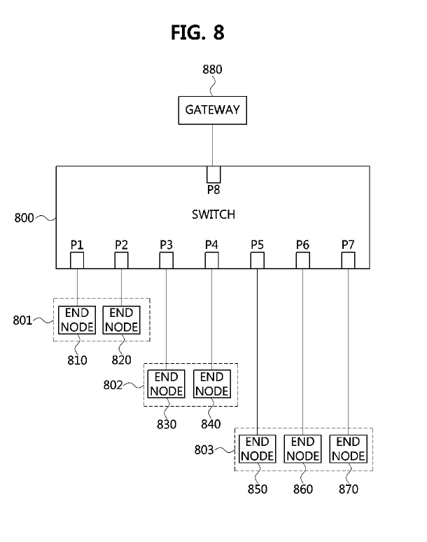

FIG. 8 is a block diagram illustrating a third exemplary embodiment of a vehicle network topology to which a port based VLAN technology is applied.

As shown in FIG. 8, a switch 800 may support layer-2 functions. Domains 801, 802, and 803 may be assigned to respective ports of the switch 800. For example, end nodes 810 and 820 connected to ports P1 and P2 of the switch 800 may belong to a first domain 801, end nodes 830 and 840 connected to ports P3 and P4 of the switch 800 may belong to a second domain 802, and end nodes 850, 860, and 870 connected to ports P5, P6, and P7 may belong to a third domain 803.

A gateway 880 may be connected to a port P8 of the switch 800. A link between the switch 800 and the gateway 880 may be different from the trunk link explained with reference to FIG. 4. The port P8 of the switch 800 may be used commonly by the domains 801, 802, and 803. For example, in a case that the port P8 is used for the first domain 801, frames generated by the end nodes 810 and 820 belonging to the first domain 801 may be transmitted through the port P8 of the switch 800. In a case that the port P8 is used for the second domain 802, frames generated by the end nodes 830 and 840 belonging to the second domain 802 may be transmitted through the port P8 of the switch 800. In a case that the port P8 is used for the third domain 803, frames generated by the end nodes 850, 860, and 870 belonging to the third domain 803 may be transmitted through the port P8 of the switch 800.

The gateway 880 may comprise a single NIC, and accordingly configure a single physical MAC address. Also, the gateway 880 may configure MAC addresses for respective domains. In the case that the gateway 880 supports three domains 801, 802, and 803, the gateway 880 may further configure two virtual MAC addresses. The gateway 880 may use the physical MAC address for the first domain 801, the first virtual MAC address for the second domain 802, and the second virtual MAC address for the third domain 803.

Table 3 below shows mapping relations among domains, ports, and MAC addresses. Here, the MAC addresses may be MAC addresses of communication nodes connected to the corresponding ports. Communication nodes constituting the vehicle network may have the mapping table in advance.

TABLE 3

| Domain | Port | MAC address | IP address |
|---|---|---|---|
| First | P1 | M1 | 192.168.0.11 |
| Domain | P2 | M2 | 192.168.0.12 |
| | P8 | M8 | 192.168.3.10 |
| Second | P3 | M3 | 192.168.1.11 |
| Domain | P4 | M4 | 192.168.1.12 |
| | P8 | M9 | 192.168.3.10 |
| Third | P5 | M5 | 192.168.2.11 |
| Domain | P6 | M6 | 192.168.2.12 |
| | P7 | M7 | 192.168.2.13 |
| | P8 | M10 | 192.168.3.10 |

According to Table 3, the gateway 880 may have MAC addresses for respective domains 801, 802, and 803. Also, the gateway 880 may use a single IP address regardless of the domains 801, 802, and 803. Alternatively, the gateway 880 may use different IP addresses for respective domains 801, 802, and 803.

Hereinafter, methods for communications between communication nodes in a vehicle network divided into a plurality of domains will be described.

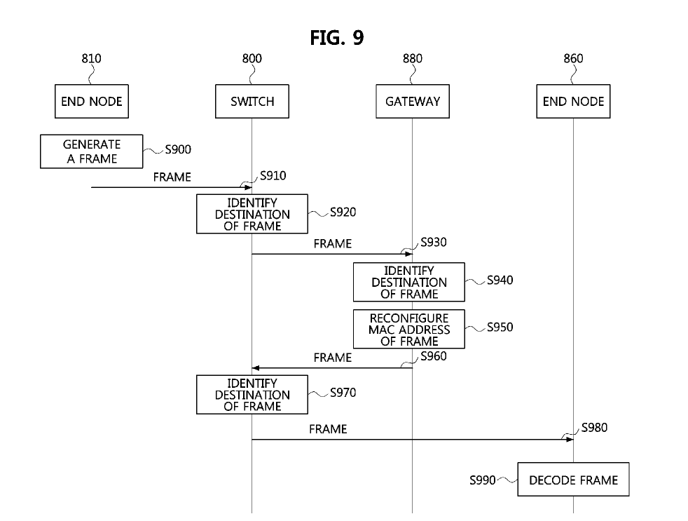

FIG. 9 is a sequence chart illustrating a third exemplary embodiment of a communication method in a vehicle network according to the present disclosure.

As shown in FIG. 9, the switch 800, the end nodes 810 and 860, and the gateway may be the corresponding ones illustrated in FIG. 8, and constitute the vehicle network explained with reference to FIG. 8.

The end node 810 belonging to the first domain 801 may generate a frame to be transmitted to the end node 860 belonging to the third domain 803 (S900). The frame may comprise address information and a payload. A destination IP address of the frame may be configured as 192.168.2.12 which is the IP address of the end node 860, and a source IP address of the frame may be configured as 192.168.0.11 which is the IP address of the end node 810. The destination MAC address of the frame may be configured as M8 which is the MAC address for the first domain 801 among MAC addresses of the gateway 880, and the source MAC address of the frame may be configured as M1 which is the MAC address of the end node 810. The end node 810 may transmit the frame to the switch 800 through the port P1 (S910).

The switch 800 may receive the frame from the end node 810. Since the frame is received through the port P1, the switch 800 may identify that the frame has been transmitted from the end node 810 connected to the port P1. Additionally or alternatively, the switch 800 may identify that the frame has been transmitted from the end node 810 by checking the source MAC address of the received frame. The switch 800 may identify the destination of the frame by checking the destination MAC address of the received frame (S920). Since the destination MAC address of the frame is M8 which is the MAC address for the first domain 801 among MAC addresses of the gateway 880, the switch 800 may identify that the destination of the frame is the gateway 880. Accordingly, the switch 800 may transmit the frame to the gateway 880 through the port P8 (S930). Here, since the switch 800 does not support layer-3 functions, the switch 800 cannot identify IP addresses in the frame, and thus the switch 800 may identify the destination and source of the frame by using the destination MAC address and source MAC address of the frame.

The gateway 880 may receive the frame from the switch 800. The gateway 880 may identify, based on the source MAC address (e.g., the source MAC address configured as M1) or the source IP address (e.g., the source IP address configured as 192.168.0.11), that the source of the frame is the end node 810. Also, the gateway 880 may identify the destination of the frame by checking the destination MAC address or the destination IP address of the received frame (S940). Since the destination MAC address of the frame is configured as M8 for the first domain 801 among MAC addresses of the gateway 880, the gateway 880 may identify the destination of the frame is the gateway 880. Also, since the destination IP address of the frame is configured as 192.168.2.12 which is the IP address of the end node 860, the gateway 880 may identify that the final destination of the frame is the end node 860 belonging to the third domain 803.

The gateway 880 may reconfigure the MAC addresses of the frame by considering the final destination of the frame and the domain to which the final destination belongs (S950). For example, in a case that a domain to which a communication node corresponding to the destination MAC address of the frame belongs is different from a domain to which a communication node corresponding to the destination IP address of the frame belongs, or in a case that a domain to which the source of the frame (e.g., the end node 810) belongs is different from a domain to which the final destination of the frame (e.g., the end node 860) belongs, the gateway 880 may reconfigure the MAC addresses of the frame. The gateway 880 may change the destination MAC address of the frame from M8 to M6 which is the MAC address of the end node 860, and the source MAC address of the frame from M1 to M10 which is the MAC address for the third domain 803 among MAC addresses of the gateway 880. Here, the IP addresses of the frame may not be changed. The gateway 880 may transmit the frame whose MAC addresses have been changed to the switch 800 through the port P8 (S960).

The switch 800 may receive the frame from the gateway 880. Since the frame is received through the port P8, the switch 800 may identify that the frame has been transmitted from the gateway 880 connected to the port P8. Additionally or alternatively, the switch 800 may identify that the frame has been transmitted from the gateway 880 by checking the source MAC address of the received frame. The switch 800 may identify the destination of the frame by checking the destination MAC address of the received frame (S970). Since the destination MAC address of the frame is M6 which is the MAC address of the end node 860 belonging to the third domain 803, the switch 800 may identify that the destination of the frame is the end node 860. Accordingly, the switch 800 may transmit the frame to the end node 860 through the port P6 (S980).

The end node 860 may receive the frame from the switch 800, and identify that the destination of the frame is the end node 860 by checking the destination MAC (or, IP) address of the received frame. Accordingly, the end node 860 may decode the payload included in the frame (S990).

Hereinafter, a vehicle network divided by gateways and an external network will be described. Here, the external network may be a network located externally from a vehicle.

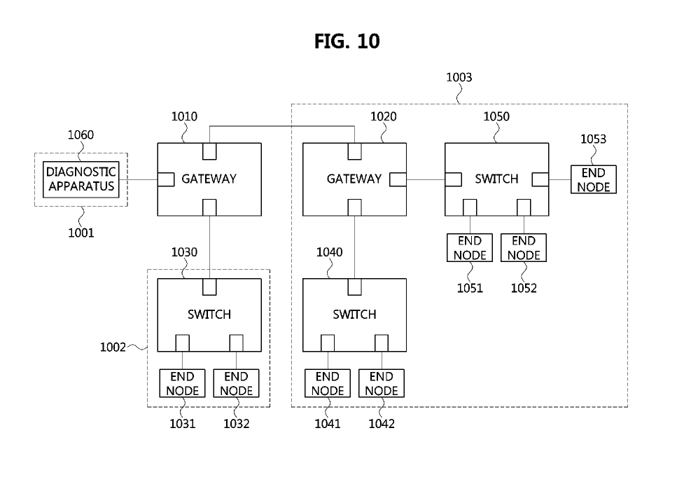

FIG. 10 is a block diagram illustrating a fourth exemplary embodiment of a vehicle network topology to which a port based VLAN technology is applied.

As shown in FIG. 10, gateways 1010 and 1020, switches 1030, 1040, and 1050, and end nodes 1031, 1032, 1041, 1042, 1051, 1052, and 1053 may constitute a vehicle network. A diagnostic apparatus 1060 may constitute an external network, and belong to a first domain 1001. Also, the diagnostic 1060 may perform diagnostic functions and reprogramming functions for the vehicle network. The switch 1030 and end nodes 1031 and 1032 may belong to a second domain 1002, and communication nodes belonging to the second domain 1022 may form a local interconnect network (LIN). The gateway 1020, switch 1040, switch 1050, end node 1041, end node 1042, end node 1051, end node 1052, and end node 1053 may belong to a third domain 1003. The switch 1040, end node 1041, and end node 1042 may form a CAN-based network. The switch 1050, end node 1051, end node 1052, and end node 1053 may form an Ethernet-based network.

The gateway 1010 may support communications among the plurality of domains 1001, 1002, and 1003 in the manner identical to or similar with that of the gateway 880 explained with reference to FIG. 8 and FIG. 9. For example, the gateway 1010 may include a single NIC, and accordingly have a single physical MAC address. Also, the gateway 1010 may configure MAC addresses for respective domains. Since the gateway 1010 supports three domains 1001, 1002, and 1003, the gateway 1010 may further generate two virtual MAC addresses. The gateway 1010 may use the physical MAC address for communications with the communication nodes belonging to the first domain 1001, a first virtual MAC address for communications with the communication nodes belonging to the second domain 1002, and a third virtual MAC address for communications with the communication nodes belonging to the third domain 1003. Through this, the vehicle network can be separated from the external network so that security of the vehicle network can be guaranteed.

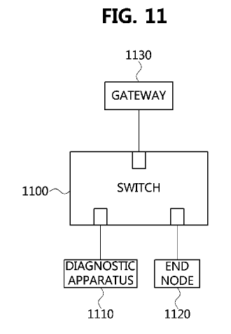

FIG. 11 is a block diagram illustrating a fifth exemplary embodiment of a vehicle network topology to which a port based VLAN technology is applied.

As shown in FIG. 11, each of switch 1100 and gateway 1130 may support communications among a plurality of domains 1001, 1002, and 1003 in the manner identical to or similar with that of the switch 800 and the gateway 880 explained referring to FIG. 8 and FIG. 9. The switch 1100 may support layer-2 functions, and the gateway 1130 may include a single NIC. A diagnostic apparatus 1110 may perform diagnostic functions and reprogramming functions for the vehicle network, and belong to the first domain 1001. An end node 1120 may belong to the second domain 1002.

The gateway 1130 may have a single physical MAC address, and may configure MAC addresses for respective domains. Since the gateway 1010 supports two domains, the gateway 1130 may further generate a virtual MAC addresses. The gateway 1130 may use the physical MAC address for communications with the diagnostic apparatus 1110 belonging to the first domain, and the virtual MAC address for communications with the end node 1120 belonging to the second domain. Also, the gateway 1130 may configure IP addresses for respective domains. For example, the gateway 1130 may obtain an IP address generated based on a dynamic host configuration protocol (DHCP) from the diagnostic apparatus 1110, and use the obtained IP address as the IP address for the first domain.

The methods according to embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software. Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the operation of the present disclosure, and vice versa.

While the embodiments of the present disclosure and their advantages have been described in detail above, it should be understood that various changes, substitutions and alterations may be made herein without departing from the scope of the disclosure.

What is claimed is:

1. An operation method of a first end node belonging to a first domain in a vehicle network, the method comprising:
generating a frame; and
transmitting the frame to a switch connected to the first end node,
wherein a source internet protocol (IP) address of the frame is set to an IP address of the first end node, a destination IP address of the frame is set to an IP address of a second end node belonging to a second domain in the vehicle network, a source medium access control (MAC) address of the frame is set to a MAC address of the first end node, and a destination MAC address of the frame is set to a MAC address of a gateway supporting inter-domain communications.

2. The operation method according to claim 1, wherein the switch supports layer-2 functions and configures domains for respective ports of the switch.

3. The operation method according to claim 1, wherein the gateway has MAC addresses for the first and second domains, and a MAC address of the gateway set as the destination MAC address of the frame is a MAC address configured for the first domain.

4. The operation method according to claim 1, wherein the gateway has a plurality of MAC addresses, one of the plurality of MAC addresses is a physical MAC address, and the remainder of the plurality of MAC addresses are virtual MAC addresses.

5. An operation method of a switch in a vehicle network, the method comprising:
receiving a frame from a first end node belonging to a first domain in the vehicle network;
identifying a communication node indicated by a destination medium access control (MAC) address of the frame; and
transmitting the frame to a gateway supporting inter-domain communications when the identified communication node is the gateway.

6. The operation method according to claim 5, wherein a source internet protocol (IP) address of the frame is set to an IP address of the first end node, and a destination IP address of the frame is set to an IP address of a second end node belonging to a second domain in the vehicle network.

7. The operation method according to claim 5, wherein the destination MAC address of the frame is a MAC address configured for the first domain.

8. The operation method according to claim 5, wherein the switch supports layer-2 functions and configures domains for respective ports of the switch.

9. The operation method according to claim 5, wherein the frame is received from the first end node through a first port configured for the first domain.

10. The operation method according to claim 5, further comprising:
receiving the frame from the gateway;
identifying a communication node indicated by a changed destination MAC address of the frame received from the gateway; and
transmitting the frame to a second end node belonging to a second domain in the vehicle network when the identified communication node is the second end node.

11. The operation method according to claim 10, wherein a source MAC address of the frame received from the gateway is a MAC address configured for the second domain.

12. The operation method according to claim 10, wherein the frame is received from the second end node through a second port configured for the second domain.

13. An operation method of a gateway in a vehicle network, the method comprising:
receiving a frame from a switch;
changing a destination medium access control (MAC) address of the frame to a MAC address of an end node indicated by a destination internet protocol (IP) address of the frame when the frame is used for communication between end nodes belonging to different domains; and
transmitting the frame having the changed destination MAC address to the switch.

14. The operation method according to claim 13, wherein the destination MAC address of the frame received from the switch is a MAC address configured for a domain to which an end node indicated by a source IP address or a source MAC address of the frame belongs.

15. The operation method according to claim 13, wherein the frame is used for communication between end nodes belonging to different domains when a domain to which an end node indicated by a source IP address or a source MAC address of the frame belongs is different from a domain to which an end node indicated by the destination IP address of the frame belongs.

16. The operation method according to claim 13, wherein the frame is used for communication between end nodes belonging to different domains when a domain corresponding to a MAC address of the gateway which is configured as the destination MAC address of the frame is different from a domain to which an end node indicated by the destination IP address of the frame belongs.

17. The operation method according to claim 13, wherein a source MAC address of the frame is changed to a MAC address configured for a domain to which an end node indicated by the destination IP address of the frame belongs.

18. The operation method according to claim 13, wherein the gateway supports inter-domain communications and has MAC addresses configured for one or more domains.

19. The operation method according to claim 13, wherein the gateway has a plurality of MAC addresses, one of the plurality of MAC addresses is a physical MAC address, and the remainder of the plurality of MAC addresses are virtual MAC addresses.

20. The operation method according to claim 13, wherein the gateway includes a single network interface card (NIC).
